(19) United States
(12) Patent Application Publication
(10) Pub. No.: US 2023/0107387 A1
(43) Pub. Date: Apr. 6, 2023

(54) ABNORMAL STATE MONITORING SYSTEM FOR MOBILE BODY

(71) Applicant: HITACHI, LTD., Tokyo (JP)

(72) Inventors: Akinobu WATANABE, Tokyo (JP); Keiichi MITANI, Tokyo (JP); Atsushi NEO, Tokyo (JP); Satoshi OUCHI, Tokyo (JP)

(21) Appl. No.: 17/798,674

(22) PCT Filed: Oct. 13, 2020
(86) PCT No.: PCT/JP2020/038633

§ 371 Date: Aug. 10, 2022

(30) Foreign Application Priority Data
Feb. 18, 2020 (JP) 2020-025142

(51) Int. Cl. G05D 1/00; E02F 9/26

(52) U.S. Cl. CPC G05D 1/0027; E02F 9/267; G05D 2201/0202

(57) ABSTRACT

An abnormal state monitoring system (100) for a mobile body includes a management device (30) that, based on unsteady information of an abnormal state transmitted from a plurality of the mobile bodies, transmits instruction information to the mobile bodies, and a mobile body side device (10) provided in each of the mobile bodies. The mobile body side device (10) includes a communication unit (25) that communicates with the management device (30), a sensor information acquisition unit (12) that acquires sensor information of a plurality of sensors, an abnormality detection unit (13) that determines whether or not the sensor information is abnormal, and an abnormality processing unit (14) that generates flag data (21) including a flag indicating an abnormality level and state information indicating an abnormal state when the abnormality detection unit (13) determines that there is an abnormality, and transmits the flag data (21) to the management device (30).

### TECHNICAL FIELD

The present invention relates to an abnormal state monitoring system for a mobile body capable of appropriately processing collected information from a plurality of mobile bodies.

### BACKGROUND ART

In the field of construction machines, an ultra-large heavy machine with a body weight of several hundred tons class represented by ultra-large excavators and the like are operated in various places of the world for earthmoving work in vast mines. Such an ultra-large heavy machine is required to be continuously operated in order to improve productivity by ore collection. In order to prevent the failure that prevents the continuous operation in advance, an operation data collection device is mounted on the ultra-large heavy machine to collect detailed operation data. Further, each mining company also desires cost reduction and improvement in production efficiency, and in some cases, a dump truck that autonomously operates is adopted as one of the solutions.

PTL 1 proposes an operation data collection device for a construction machine capable of efficiently collecting operation data indicating a failure or sign of the failure of a construction machine by reducing an amount of stored information to be collected and accumulated without deteriorating quality of information leading to maintenance.

### Citation List

### Patent Literature

PTL 1: JP 5841612 B2

### SUMMARY OF INVENTION

### Technical Problem

PTL 1 discloses an operation data collection device for a construction machine. The operation data collection device is mounted on a construction machine, and receives operation data including measurement values of a plurality of sensors indicating an operation status of the construction machine and stores the operation data in an operation data storage unit. The operation data collection device includes: a normal reference value storage unit that stores a normal reference value of each of the sensors of the operation data; a deviation degree calculation unit that calculates a deviation degree from the normal reference value of each of the sensors; and a storage sensor item dynamic specification unit that dynamically changes a sensor item of the operation data stored in the operation data storage unit according to a magnitude of the deviation degree of each of the sensors calculated by the deviation degree calculation unit. The storage sensor item dynamic specification unit compares magnitudes of the deviation degrees from the normal reference value of each of the sensors with each other, and can sequentially select sensor items of the sensors having a large deviation degree and store the selected sensor items in the operation data storage unit.

However, when operation data including measurement values of a plurality of sensors indicating an operation status of a construction machine is received from a large number of construction machines operating in various places of the world, there is a problem that an instruction cannot be promptly issued from a remote monitoring center when there is an abnormality sign in each construction machine due to an increase in received information. Further, although a large number of site workers are working in a construction site, it is necessary to grasp not only the situation of the construction machine but also the situation of a large number of site workers.

The present invention has been made to solve the above-described problems, and an object thereof is to provide an abnormal state monitoring system for a mobile body capable of appropriately processing collected information from a plurality of mobile bodies (for example, a construction machine, a site worker).

### Solution to Problem

In order to achieve the above object, an abnormal state monitoring system for a mobile body of the present invention includes: a management device that, based on unsteady information of an abnormal state transmitted from a plurality of the mobile bodies, transmits instruction information to the mobile bodies; and a mobile body side device provided in each of the mobile bodies, wherein the mobile body side device includes: a communication unit that communicates with the management device; a sensor information acquisition unit that acquires sensor information of a plurality of sensors; an abnormality detection unit that determines whether or not the sensor information is abnormal; and a control unit that generates flag data including a flag indicating an abnormality level and state information indicating an abnormal state when the abnormality detection unit determines that there is an abnormality, and transmits the flag data to the management device. Other aspects of the present invention will be described in the following embodiments.

### Advantageous Effects of Invention

According to the present invention, an abnormal state monitoring system for a mobile body capable of appropriately processing collected information from a plurality of mobile bodies is provided.

### BRIEF DESCRIPTION OF DRAWINGS

FIG. 1 is a diagram illustrating an outline of an abnormal state monitoring system for a mobile body according to an embodiment.

FIG. 2 is a diagram illustrating a configuration of an abnormal state monitoring system of a mobile body.

FIG. 3 is a diagram illustrating an example of a data structure of flag data.

FIG. 4 is a diagram illustrating an example of a data structure of notification data from a management device.

FIG. 5 is a diagram illustrating an example of an acquired data determination table in processing S1.

FIG. 6 is a diagram illustrating an example of an instruction determination table of processing S2.

FIG. 7 is a flowchart illustrating overall processing of the abnormal state monitoring system of the mobile body.

FIG. 8 is a flowchart illustrating flag generation processing in the mobile body.

FIG. 9 is a flowchart illustrating priority determination processing of a plurality of flags in the management device.

FIG. 10 is a flowchart illustrating sensing data selection processing of processing S1 in the management device.

FIG. 11 is a flowchart illustrating sensing data analysis processing in processing S2 in the management device.

FIG. 12 is a diagram illustrating instruction contents based on flag data and sensing data in processing S2.

### DESCRIPTION OF EMBODIMENTS

Hereinafter, embodiments of the present invention will be described in detail with reference to the drawings.

### Outline of Abnormal State Monitoring System 100 of Mobile Body

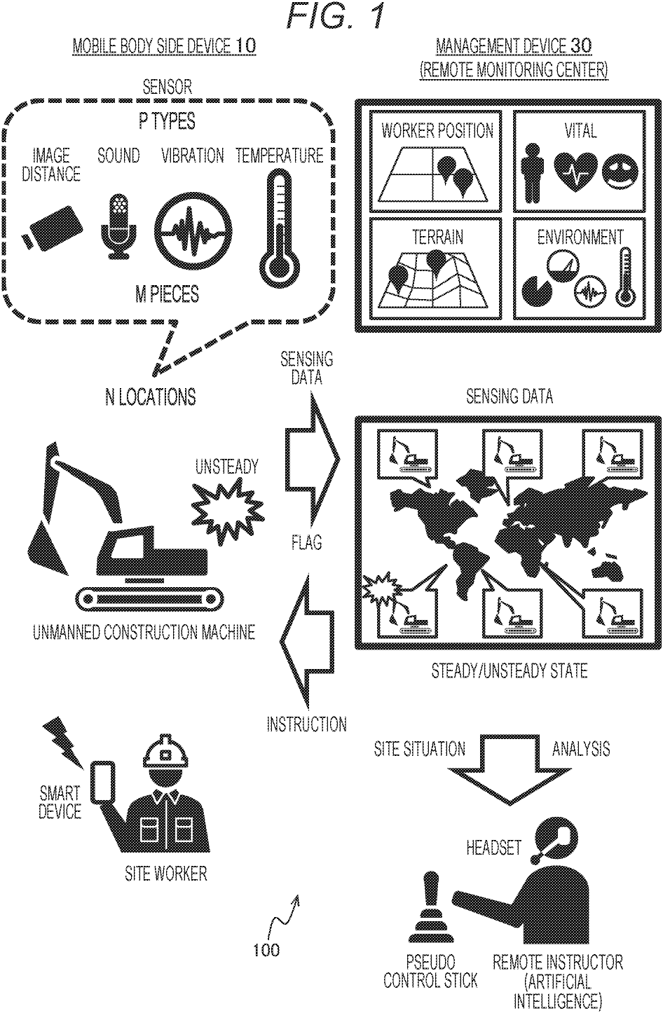

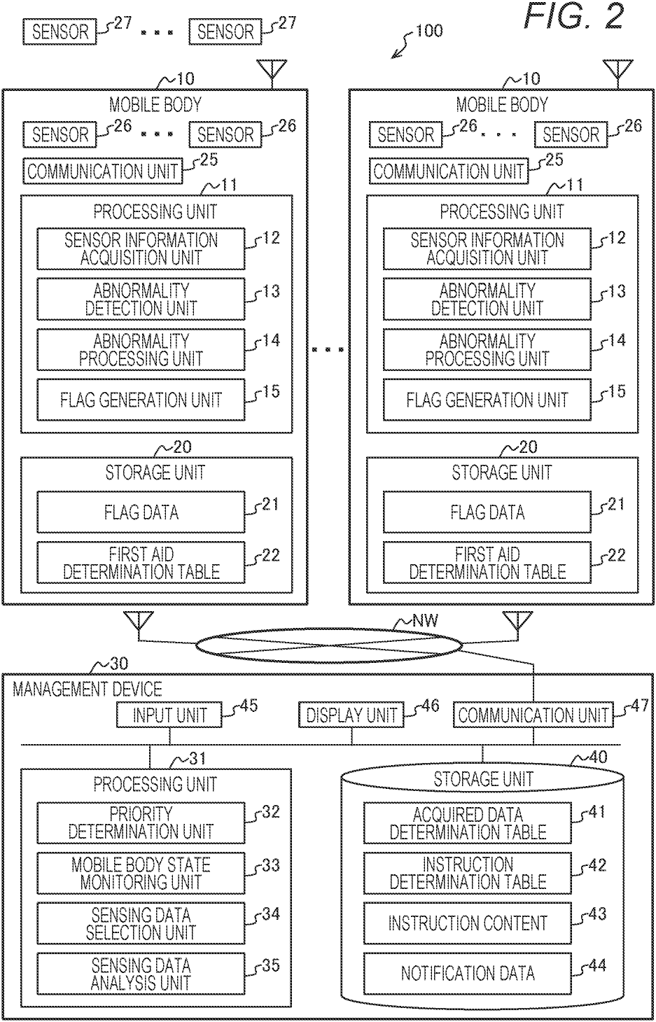

FIG. 1 is a diagram illustrating an outline of an abnormal state monitoring system 100 for a mobile body according to an embodiment. FIG. 2 is a diagram illustrating a configuration of an abnormal state monitoring system of a mobile body. The abnormal state monitoring system 100 for a mobile body includes a management device 30 (remote monitoring center) that monitors an unsteady state from a plurality of the mobile bodies including a large number of construction machines operating around the world or persons who work at construction sites of the construction machines, and a mobile body side device 10 provided in each of the mobile bodies. When an unsteady state (abnormal state) occurs, the mobile body side device 10 transmits flag data 21 indicating the unsteady state to be described later to the management device 30 of the remote monitoring center. The management device 30 analyzes the flag data 21 and requests necessary sensing data from the mobile body side device 10. The mobile body side device 10 transmits the requested sensing data to the management device 30, and the management device 30 transmits instruction information to the mobile body side device 10 on the basis of the flag data and the sensing data.

The abnormal state monitoring system 100 for a mobile body is provided at N locations of M sensors, and uses P types of sensor information. M, N, and P mean sensors provided in an unmanned construction machine illustrated in FIG. 1 and sensors provided around the sensors. In other words, M, N, and P mean sensors provided in the mobile body side device 10 and sensors provided around the sensors. Examples of the P types of sensors include an image distance sensor, an audio sensor, a vibration sensor, and a temperature sensor. Further, in the case of a person, sensors and the like may be provided in a smart device possessed by the person.

As an example of the mobile body, a case of an unmanned construction machine that autonomously travels at a construction site will be described.

In a steady state, the unmanned construction machine constantly senses a change in a surrounding environment and a change in an own state by a plurality of sensors while proceeding with work according to a programmed plan, and continues to check whether or not there is an abnormal value greater than or equal to a threshold value in an output result from each sensor. As a result of the check, when an abnormal value greater than or equal to the threshold value is detected, the state transitions from the steady state to an unsteady state.

When the state transitions to the unsteady state, first, a preset first aid is executed according to an abnormal value of the sensor. Next, the flag data 21 is generated based on the output result from each sensor. Further, the generated flag data 21 is notified to the management device 30 via a network NW. After the flag data 21 is notified, reception of an instruction from the management device 30 is awaited. The instruction from the management device 30 includes an instruction by processing S1 and an instruction by processing S2 to be described later.

Note that, although the unmanned construction machine that autonomously travels at the construction site has been described as the mobile body, the same applies to the case of a site worker. In the case of the site worker, it is preferable that the site worker has (wears) a smart device including various sensors, a processing unit, and the like, a smart watch, and the like as the mobile body side device 10.

### Device Configuration of Abnormal State Monitoring System 100 of Mobile Body

Next, a device configuration will be described with reference to FIG. 2.

When the flag data 21 is received as processing S1, the management device 30 issues an instruction to acquire necessary sensing data. Further, when the sensing data is received as processing S2, the management device 30 analyzes the flag data and the sensing data, and issues the best response instruction to the unmanned construction machine at the construction site via the network NW according to a result of the analysis.

The mobile body side device 10 includes a processing unit 11 that monitors an unsteady state of the mobile body, a storage unit 20, a communication unit 25 that communicates with the external sensors 27 and the management device 30, and a plurality of internal sensors 26. The processing unit 11 includes a sensor information acquisition unit 12 (sensor information acquisition means) that acquires sensor information of the plurality of sensors 26 and 27, an abnormality detection unit 13 (abnormality detection means) that determines whether or not the sensor information is abnormal, an abnormality processing unit 14 (control means) that generates the flag data 21 including a flag indicating an abnormality level and state information indicating an abnormal state when the abnormality detection unit determines that there is an abnormality, and transmits the flag data 21 to the management device 30, a flag generation unit 15 that generates a flag, and the like. The storage unit 20 stores the flag data 21, a first aid determination table 22, and the like.

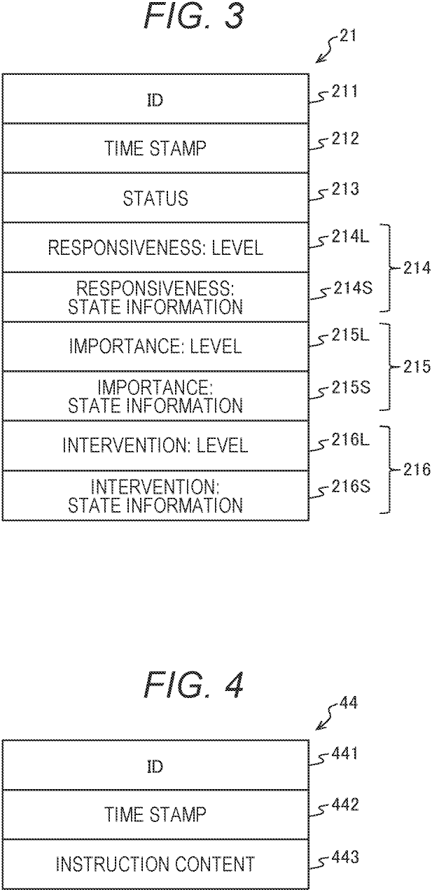

FIG. 3 is a diagram illustrating an example of a data structure of the flag data 21. The flag data 21 includes an ID 211 for identifying the mobile body side device 10 that has generated the flag, and a notification event, a time stamp 212 indicating the time at which the flag data has been generated, a status 213 indicating a steady/unsteady state, responsiveness information 214 determined based on an abnormal value from the sensors, importance information 215, and intervention information 216. The responsiveness information 214, the importance information 215, and the intervention information 216 include levels 214L, 215L, and 216L, which are flag levels of the respective information, and state information 214S, 215S, and 216S indicating states of the levels.

The responsiveness information 214 is information for determining whether or not an abnormality of a person (site worker) or an influence on a person is given. When it is determined that there is an abnormality of a person or an influence on a person, the responsiveness level is set to “1” . Next, it is determined whether or not a change in a surrounding environment or a change in a state of the machine is fast. If it is determined that it is fast, the responsiveness level is set to “2”. Otherwise, the responsiveness level is set to “3”.

The importance information 215 is information for determining whether or not the surrounding environment is greatly affected. When it is determined that the influence is large, the importance level is set to “1”. Next, it is determined whether or not it leads to breakage of an unmanned construction machine or equipment used. When it is determined that the damage is caused, the importance level is set to “2”. Otherwise, the importance level is “3”.

Intervention information 216 is information for determining whether or not intervention by an expert is required among remote instructions. If it is determined that the intervention by the expert is required, the intervention level is set to “1”. Next, it is determined whether or not intervention by artificial intelligence is required. If it is determined that it is required, the intervention level is set to “2”. Otherwise, the intervention level is “3”.

Returning to FIG. 2, the configuration of the management device 30 will be described.

The management device 30 includes a processing unit 31, a storage unit 40, an input unit 45, a display unit 46, and a communication unit 47. The processing unit 31 includes a priority determination unit 32 that performs priority determination when a plurality of pieces of the flag data are received, a mobile body state monitoring unit 33 that monitors states of the mobile body and the surrounding environment, a sensing data selection unit 34 that generates instruction information of sensing data for grasping the state of the mobile body, a sensing data analysis unit 35 that generates a response instruction to the mobile body, and the like.

The display unit 46 is a display or the like, and displays an execution status, an execution result, and the like of processing by the management device 30. The input unit 45 is a device for inputting an instruction to a computer such as a keyboard and a mouse, and inputs an instruction such as program activation. The processing unit 31 is a central processing unit (CPU), and executes various programs stored in the storage unit 40 or the like. The communication unit 47 exchanges various data and commands with other devices via the network NW.

The storage unit 40 stores an acquired data determination table 41 to be acquired on the basis of the flag data 21 from the mobile body side device 10 used in the processing S1, an instruction determination table 42 for a response instruction to the mobile body side device 10 used in the processing S2, an instruction content 43 based on the flag data 21 and the sensing data, notification data 44 to the mobile body, and the like.

FIG. 4 is a diagram illustrating an example of a data structure of the notification data 44 from the management device 30. The notification data 44 includes an ID 441 for identifying the mobile body side device 10 that has generated the flag, and a notification event, a time stamp 442 that is the time when the notification has been generated, instruction content 443, and the like.

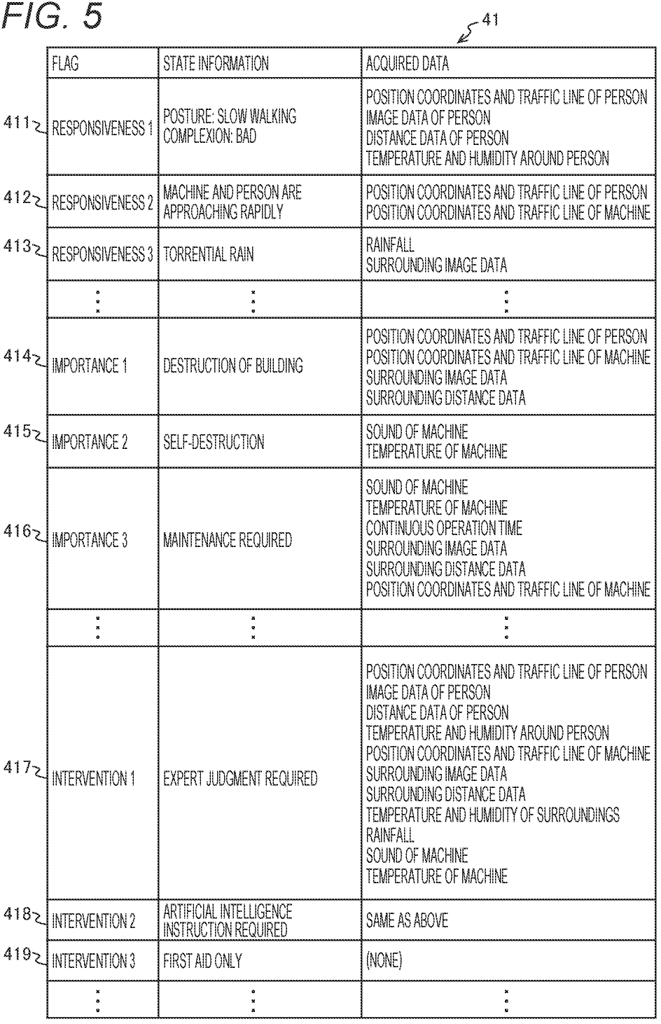

FIG. 5 is a diagram illustrating an example of the acquired data determination table 41 in the processing S1. The acquired data determination table 41 includes a level of a flag, state information, acquired data, and the like. The level of the flag is the levels 214L, 215L, and 216L illustrated in FIG. 3, and the state information is the state information 214S, 215S, and 216S illustrated in FIG. 3.

Specific examples of data to be acquired will be described based on the level of the flag and the state information. When the responsiveness level in the row 411 is “1” and information indicating that the posture is slow walking and the complexion is bad is notified as the state information, the position coordinates/traffic line of a person, the image data of a person, the distance data of a person, and the temperature and humidity around a person are acquired.

When the responsiveness level in the row 412 is “2” and information indicating that a machine and a person are approaching rapidly is notified as the state information, position coordinates and traffic lines of a person and position coordinates and traffic lines of a machine are acquired.

When the responsiveness level of the row 413 is “3” and information of torrential rain is notified as the state information, rainfall and surrounding image data are acquired.

When the importance level in the row 414 is “1” and information indicating destruction of a building is notified as the state information, position coordinates and traffic lines of a person, position coordinates and traffic lines of a machine, surrounding image data, and surrounding distance data are acquired.

When the importance level of the row 415 is “2” and information of self-destruction is notified as the state information, the sound of a machine and the temperature of a machine are acquired.

When the importance level in the row 416 is “3” and the information indicating that maintenance is required is notified as the state information, the sound of a machine, the temperature of a machine, the continuous operation time, the surrounding image data, the surrounding distance data, and the position coordinates and the traffic line of a machine are acquired.

In a case where the intervention level in the row 417 is “1” and information indicating that expert judgment is required is notified as the state information, position coordinates and traffic lines of a person, image data of a person, distance data of a person, temperature and humidity around a person, position coordinates and traffic lines of a machine, image data of the surroundings, distance data of the surroundings, temperature and humidity of the surroundings, rainfall, sound of a machine, and temperature of a machine are acquired.

When the intervention level in the row 418 is “2” and the information indicating that the artificial intelligence instruction is required is notified as the state information, the same data group as that in the case where the intervention level is “1” is acquired.

When the intervention level in the row 419 is “3” and information indicating only the first aid is notified as the state information, it is unnecessary to acquire the sensing data.

Note that, in the example of FIG. 5, three examples are shown as examples of levels of responsiveness, importance, and intervention, but the present invention is not limited thereto. For example, there is a case where the level is “1” and there are a plurality of pieces of state information.

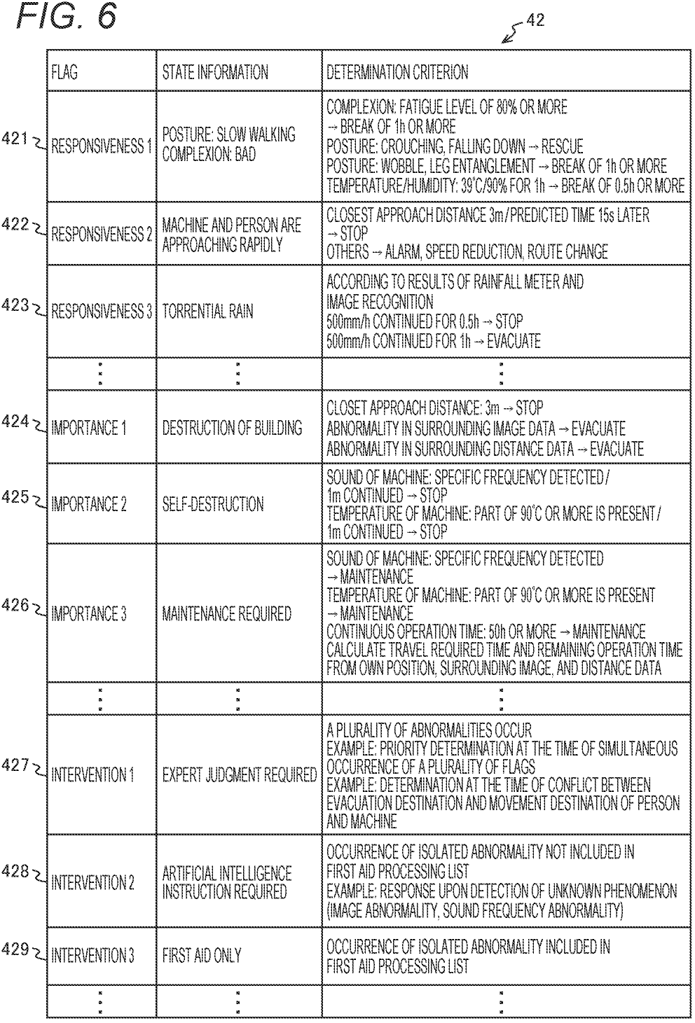

FIG. 6 is a diagram illustrating an example of the instruction determination table 42 of the processing S2. The instruction determination table 42 includes a level of a flag, state information, a determination criterion, and the like. The level of the flag is the levels 214L, 215L, and 216L illustrated in FIG. 3, and the state information is the state information 214S, 215S, and 216S illustrated in FIG. 3.

A specific example of determination criteria based on the level of the flag, the state information, and the sensing data will be described. In a case where the responsiveness level of the row 421 is “1” and information indicating that the posture is slow walking and the complexion is bad is notified as the state information, the walking speed is determined from the position coordinates and traffic line of a person, the vital state such as the complexion, the pulse, and the fatigue level is determined from the image data of a person, the posture and the fatigue level are determined from the distance data of a person, and the comfort level of the working environment is determined from the temperature and humidity around a person.

The determination criteria are as follows: if the degree of fatigue is 80% or more, a break of 1 h or more is required; if the posture is crouching or falling down, rescue is required; if the traffic line and the walking speed are wobble or the legs are entangled, a break of 1 h or more is required; and if a state in which the temperature/humidity is 39 degrees/90% is continued for 1 h, a break of 0.5 h is required. Note that h is a unit of time.

When the responsiveness level in the row 422 is “2” and information indicating that a machine and a person are approaching rapidly is notified as the state information, the predicted closest approach distance and the predicted closest approach time are determined from the position coordinates and the traffic line of the person and the position coordinates and the traffic line of the machine.

The determination criteria indicate that the machine is stopped when the closest approach distance is 3 m/predicted time is reached in 15 s, or otherwise, an alarm is issued to the person, the moving speed of the machine is reduced, and the route is changed.

When the responsiveness level of the row 423 is “3” and information of torrential rain is notified as the state information, whether or not to continue the activity is determined from the rainfall amount and the rainfall situation of the surrounding image data. As determination criteria, according to the results of the rainfall meter and the image recognition, when 500 mm/h continues for 0.5 h, a machine is stopped, and when 500 mm/h continues for 1 h, the machine is evacuated.

When the importance level in the row 424 is “1” and information about destruction of the building is notified as the state information, the closest approach distance is determined from the position coordinates and traffic line of a person and the position coordinates and traffic line of a machine, and the necessity of evacuation is determined from the surrounding image data and the surrounding distance data. In the determination criteria, when the closest approach distance is 3 m, the machine is stopped, and when an unrecognized object or an object that should not approach is detected as a result of image recognition of surrounding image data and distance data, it is determined that evacuation is required.

When the importance level of the row 425 is “2” and information of self-destruction is notified as the state information, a specific frequency at which a failure or deterioration of a component can be predicted is detected from a sound of a machine, and a portion at which a temperature reaches a temperature equal to or higher than expected is detected from a temperature. The determination criteria indicate that the machine is stopped when a specific frequency is detected and the detection state continues for 1 minute as a result of the analysis of the sound of the machine, and the machine is stopped when a site of 90 degrees or more is detected and the detection state continues for 1 minute as a result of the analysis of the temperature.

When the importance level in the row 426 is “3” and the information indicating that maintenance is required is notified as the state information, a specific frequency at which a failure or deterioration of a component can be predicted is detected from the sound of a machine, a part at which a temperature has reached a temperature equal to or higher than expected is detected from the temperature of the machine, necessity of the maintenance work is determined from the continuous operation time, and the moving time from the current location to the maintenance place is estimated from the surrounding image data and the surrounding distance data, and the position coordinates and the traffic line of the machine.

As determination criteria, it is determined that maintenance is required when a specific frequency is detected as a result of analysis of a sound of the machine, it is determined that maintenance is required when a part of 90 degrees or more is detected as a result of analysis of a temperature of the machine, it is determined that maintenance is required when a continuous operation time is 50 h or more, and a required travel time and a remaining operation time are calculated from an own position, a surrounding image, and distance data.

In a case where the intervention level in the row 427 is “1”, and information indicating that expert judgment is required is notified as the state information, a response method in a case where a plurality of abnormalities has occurred by an expert is determined on the basis of position coordinates and traffic lines of a person, image data of the person, temperature and humidity around the person, position coordinates and traffic lines of a machine, image data of the surroundings, distance data of the surroundings, temperature and humidity of the surroundings, rainfall, sound of the machine, and temperature of the machine. For example, it is a priority determination at the time of simultaneous occurrence of a plurality of flags or an evacuation instruction at the time of conflict between an evacuation destination and a movement destination of the person/machine.

In a case where the intervention level in the row 428 is “2” and the information that the artificial intelligence instruction is required is notified as the state information, the response method in a case where the isolated abnormality in which the artificial intelligence is not included in a first aid processing list has occurred is determined from the database based on the same data group as in the case where the intervention level is “1”. For example, the method is a method of coping with a case where an unknown object not in the list is recognized as a result of image recognition, or a case where an abnormal sound with a frequency not in the list is detected.

When the intervention level in the row 429 is “3” and information indicating only the first aid is notified as the state information, the determination processing is unnecessary.

### Effects of Abnormal State Monitoring System 100 of Mobile Body

Effects of the abnormal state monitoring system 100 for a mobile body include the following.

Since a size of the notification data (flag data 21 (see FIG. 3)) from the mobile body side device 10 to the management device 30 is small, even if a large number of notifications occur simultaneously from a large number of bases, the management device 30 can be notified in real time.

Since urgency and importance are determined before notification from the mobile body side device 10 to the management device 30, a processing load on the management device 30 side is small. Further, the management device 30 can easily determine the priority and can cope with a large number of mobile bodies.

When detecting the abnormality data, the mobile body side device 10 first executes the first aid with the mobile body, so that no response delay occurs.

By combining sensing by a large number of sensors, the situation of the site can be accurately grasped. For example, in sensing of a person, it is possible to more accurately grasp the state (health level, fatigue level, safety level of peripheral machines, and comfort of working environment) of a site worker by combining coordinates (position) with posture, motion, and vital information.

By analyzing the detailed sensing data by the management device 30, it is possible to create an improvement measure with higher accuracy than the analysis by the mobile body side device 10.

### Processing of Abnormal State Monitoring System 100 of Mobile Body

Hereinafter, processing of the abnormal state monitoring system 100 of a mobile body will be described.

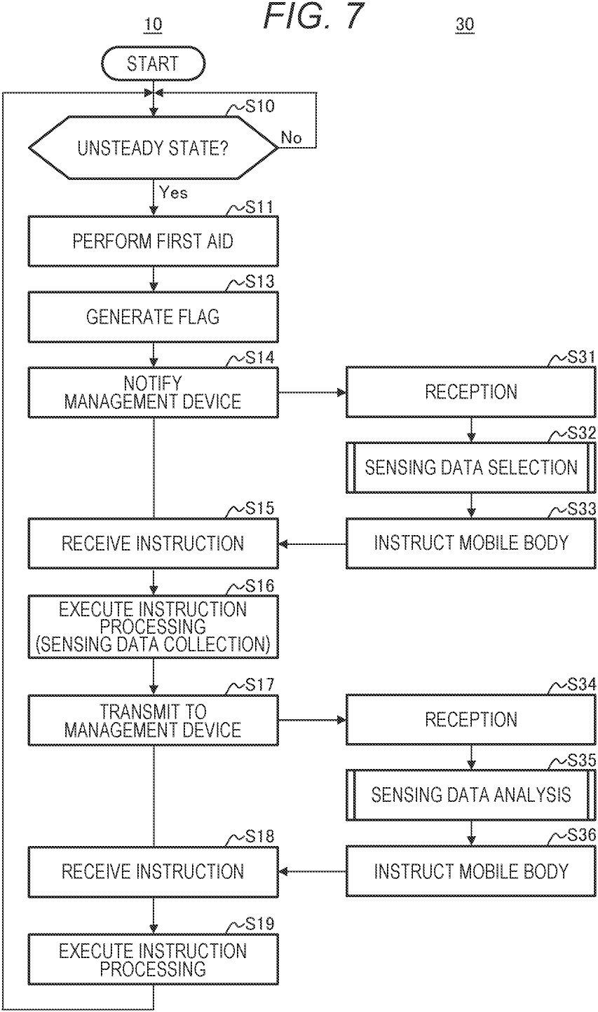

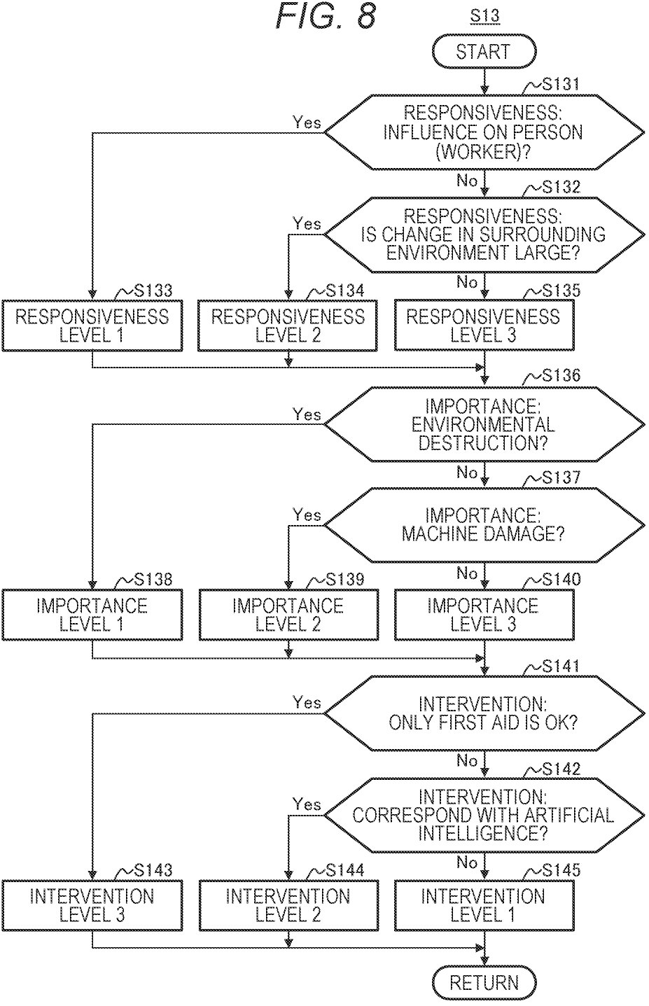

FIG. 7 is a flowchart illustrating an overall process of the abnormal state monitoring system 100 of a mobile body. The description will be appropriately made with reference to FIGS. 2 and 3. The abnormality detection unit 13 of the mobile body side device 10 determines whether or not the sensor information acquired by the sensor information acquisition unit 12 is unsteady (whether or not the sensor information is abnormal) (processing S10). If the sensor information is not unsteady (processing S10, No), the process returns to processing S10. If the sensor information is unsteady (processing S10, Yes), a first aid is performed (processing S11). The first aid corresponds to the first aid determination table 22 stored in the storage unit 20. Then, the abnormality processing unit 14 obtains the responsiveness information 214, the importance information 215, and the intervention information 216 illustrated in FIG. 3 via the flag generation unit 15 (processing S13: flag generation processing). Next, the abnormality processing unit 14 notifies the management device 30 of the flag data 21 (see FIG. 3) (processing S14).

Upon receiving the instruction from the management device 30 (processing S15), the abnormality processing unit 14 of the mobile body side device 10 executes instruction processing of sensing data collection (processing S16). Then, the abnormality processing unit 14 transmits the sensing data to the management device 30 (processing S17).

Upon receiving the instruction from management device 30 (processing S18), the abnormality processing unit 14 of the mobile body side device 10 executes the instruction processing (processing S19), and returns to processing S10.

On the other hand, upon receiving the flag data 21 from the mobile body side device 10 (processing S31), the mobile body state monitoring unit 33 of the management device 30 obtains the item of data to be acquired illustrated in FIG. 5 via the sensing data selection unit 34 (processing S32), and instructs the mobile body side device 10 to acquire the sensing data (processing S33).

Thereafter, upon receiving the sensing data from the mobile body side device 10 (processing S34), the mobile body state monitoring unit 33 of the management device 30 obtains a response instruction according to the determination criterion illustrated in FIG. 6 via the sensing data analysis unit 35 (processing S35), and issues the response instruction to the mobile body side device 10 (processing S36).

FIG. 8 is a flowchart illustrating the flag generation processing (processing S13) in the mobile body side device 10. The description will be appropriately made with reference to FIGS. 2 and 3. The flag generation unit 15 of the mobile body side device 10 determines whether or not there is an abnormality of a person (worker) or an influence on a person (processing S131). If it is determined that there is an abnormality of a person or an influence on a person (processing S131, Yes), the level 214L of the responsiveness is set to “1”, the state information 214S is set (processing S133), and the process proceeds to processing S136. When it is determined that there is no abnormality of a person or no influence on a person (processing S131, No), the flag generation unit 15 proceeds to processing S132.

Next, the flag generation unit 15 determines whether or not a change in the surrounding environment or a change in the state of the machine is fast (whether the change is large) (processing S132). If it is determined that the change is fast (processing S132, Yes), the level 214L of the responsiveness is set to “2”, the state information 214S is set (processing S134), and the process proceeds to processing S136. If the change is not fast, otherwise (processing S132, No), the flag generation unit 15 sets the responsiveness level 214L to “3”, sets the state information 214S (processing S135), and proceeds to processing S136.

The flag generation unit 15 determines whether or not the surrounding environment is greatly affected (whether the environment is destroyed) (processing S136), and if it is determined that the influence is large (processing S136, Yes), the level 215L of the importance is set to “1”, the state information 215S is set (processing S138), and the processing proceeds to processing S141. When it is determined that the influence is not large (processing S136, No), the flag generation unit 15 proceeds to processing S137.

Next, the flag generation unit 15 determines whether or not it leads to damage of the construction machine or the facility being used (processing S137) . When it is determined that damage is caused (processing S137, Yes), the flag generation unit sets the level 215L of importance to “2”, sets the state information 215S (processing S139), and proceeds to processing S141. Otherwise (processing S137, No), the importance level 215L is set to “3”, the state information 215S is set (processing S140), and the process proceeds to processing S141.

Further, flag generation unit 15 determines whether or not it is OK that only the first aid is applied (processing S141). When it is determined that it is OK that only the first aid is applied (processing S141, Yes), the level 216L of the intervention is set to “3”, the state information 216S is set (processing S143), and the flag generation processing (processing S13) ends. If it is not OK that only the first aid is applied (processing S141, No), the flag generation unit 15 proceeds to processing S142.

The flag generation unit 15 determines whether or not it is required to correspond with the artificial intelligence (processing S142) . When it is determined that it is required to correspond with the artificial intelligence (processing S142, Yes), the level 216L of the intervention is set to “2”, the state information 216S is set (processing S144), and the flag generating processing (processing S13) ends. If it is not required to cope with the case with artificial intelligence (processing S142, No), the flag generation unit 15 sets the intervention level 216L to “1”, sets the state information 216S (processing S145), and ends the flag generation processing (processing S13).

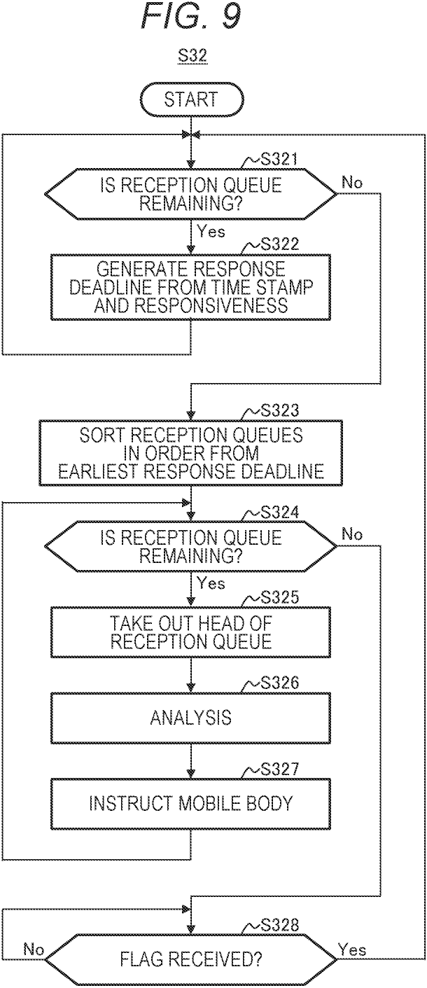

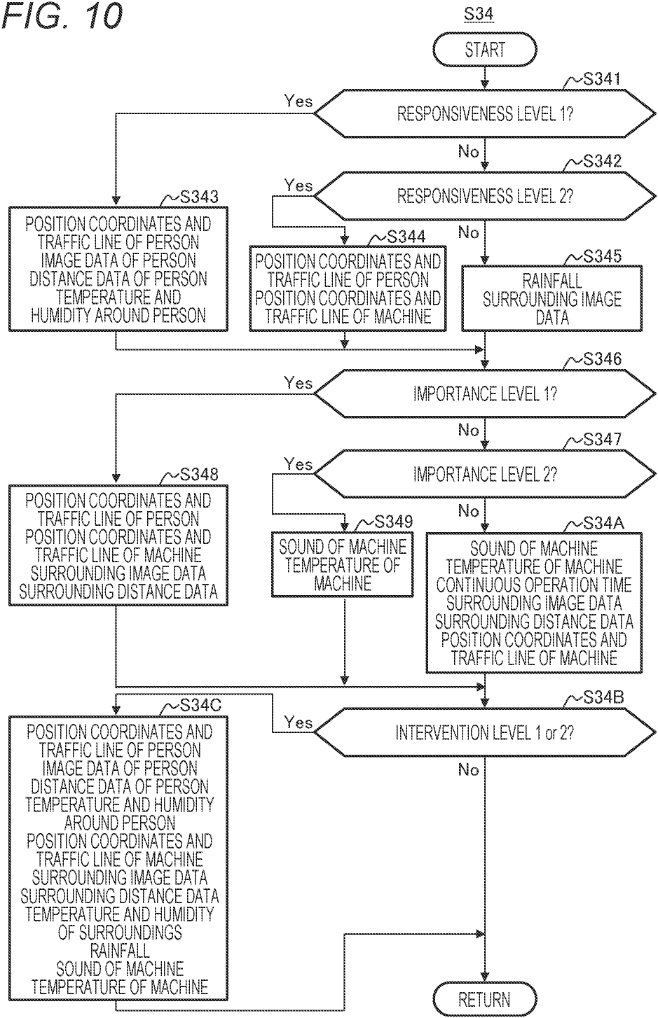

FIG. 9 is a flowchart illustrating priority determination processing (processing S32) of a plurality of flags in a management server. The description will be appropriately made with reference to FIGS. 2 and 3. The priority determination processing more specifically illustrates processing S31 to processing S36 of the mobile body state monitoring unit 33 illustrated in FIG. 7. Processing S31 and S34 in FIG. 7 correspond to processing S328 in FIG. 9, and processing S32 and S35 in FIG. 7 correspond to processing S327 in FIG. 9. Further, processing S33 and S36 in FIG. 7 correspond to processing S326 in FIG. 9.

The priority determination unit 32 of the management device 30 determines whether or not a reception queue sent from a mobile body in each place remains (processing S321), and if there is a reception queue (processing S321, Yes), generates a response deadline from the time stamp 212 of the flag data 21 and the responsiveness level 214L (processing S322), and returns to processing S321. When there is no remaining reception queue (processing S321, No), the priority determination unit 32 proceeds to processing S323.

The priority determination unit 32 sorts the reception queues in order of earliest response deadline (processing S323), and determines whether there is a remaining reception queue that has not been processed yet (processing S324). If there is a remaining reception queue (processing S324, Yes), the process proceeds to processing S325, and if there is no reception queue (processing S324, No), the process proceeds to processing S328.

Then, the priority determination unit 32 takes out a head of the reception queue (processing S325), analyzes processing S1 or processing S2 (processing S326), transmits instruction information to the mobile body (processing S327), and returns to processing S324.

In processing S328, the priority determination unit 32 determines whether or not the flag data 21 is received from the mobile body side device 10. In a case where the flag data 21 is not received (processing S328, No), the process returns to processing S328. In a case where the flag data 21 is received (processing S328, Yes), the process returns to processing S321.

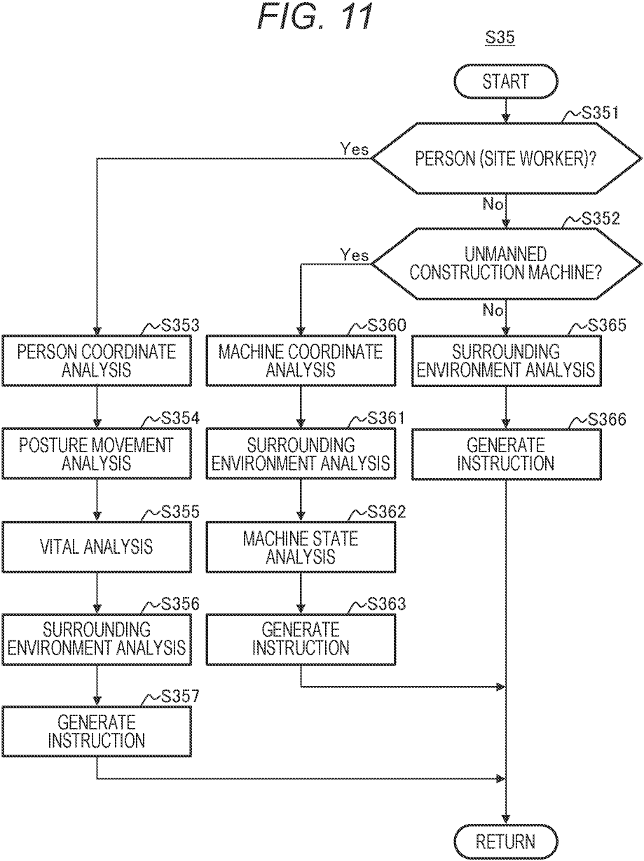

FIG. 10 is a flowchart illustrating sensing data selection processing (processing S34) of processing S1 in the management device 30. FIGS. 2 and 3 are appropriately referred to. The sensing data selection unit 34 selects sensing data necessary for analysis based on the acquired data determination table 41.

The sensing data selection unit 34 determines whether the responsiveness level is “1” (processing S341). When the responsiveness level is “1” and the information that the posture is slow walking and the complexion is bad is notified as the state information (processing S341, Yes), the sensing data selection unit selects the position coordinates/traffic line of the person, the image data of the person, the distance data of the person, and the temperature and humidity around the person as the acquired data (processing S343), and the process proceeds to processing S346. When the responsiveness level is not “1” (processing S341, No), the sensing data selection unit 34 proceeds to processing S342.

The sensing data selection unit 34 determines whether or not the responsiveness level is “2” (processing S342). When the responsiveness level is “2” and the information indicating that a machine and a person are approaching rapidly is notified as the state information (processing S342, Yes), the sensing data selector selects the position coordinates and the traffic line of the person and the position coordinates and the traffic line of the machine as the acquired data (processing S344), and the processing proceeds to processing S346. When the responsiveness level is not “2” (processing S342, No), the sensing data selection unit 34 proceeds to processing S345.

In processing S345, when the responsiveness level is “3” and information of torrential rain is notified as the state information, the sensing data selection unit 34 selects rainfall and surrounding image data as the acquired data, and the processing proceeds to processing S346.

In processing S346, the sensing data selection unit 34 determines whether or not the importance level is “1”, and in a case where the importance level is “1” and the information of the destruction of the building is notified as the state information (processing S346, Yes), selects the position coordinates/traffic line of a person, the position coordinates/traffic line of a machine, the surrounding image data, and the surrounding distance data as the acquired data (processing S348), and the processing proceeds to processing S34B. When the importance level is not “1” (processing S346, No), the sensing data selection unit 34 proceeds to processing S347.

When the importance level is “2” and the information of self-destruction is notified as the state information (processing S347, Yes), the sensing data selection unit 34 selects the sound of a machine and the temperature of the machine as the acquired data (processing S349), and proceeds to processing S34B. When the importance level is not “2” (processing S347, No), the sensing data selection unit 34 proceeds to processing S34A.

In processing 34A, in a case where the importance level is “3” and the information indicating that maintenance is required is notified as the state information, the sensing data selection unit 34 selects the sound of a machine, the temperature of the machine, the continuous operation time, the surrounding image data, the surrounding distance data, and the position coordinates/traffic line of the machine as the acquired data, and the processing proceeds to processing S34B.

In processing S34B, the sensing data selection unit 34 determines whether or not the intervention level is “1” or “2”, and in a case where information indicating that expert determination is required and that artificial intelligence instruction is required is notified as the state information (processing S34B, Yes), selects, as the acquired data, the position coordinates and traffic line of a person, the image data of the person, the ambient temperature and humidity of the person, the position coordinates and traffic line of a machine, the ambient image data, the ambient distance data, the ambient temperature and humidity, the rainfall, the sound of the machine, and the temperature of the machine (processing S34C), and ends the sensing data selection processing (processing S34) of the processing S1. If the intervention level is not “1” or “2” (processing S34B, No), the sensing data selection processing in processing S1 (processing S34) ends.

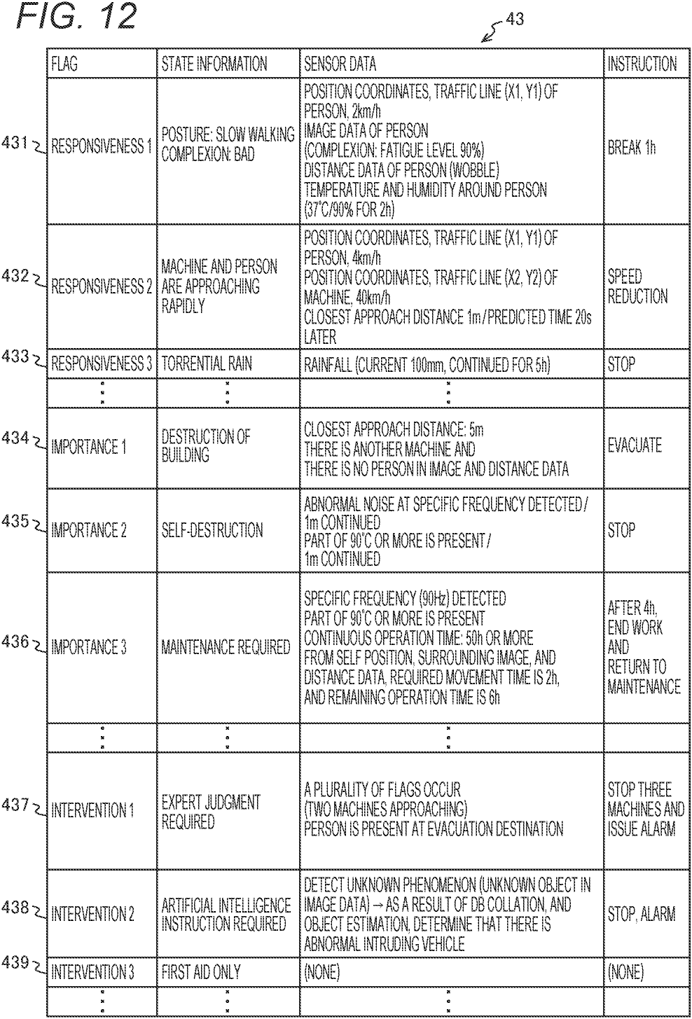

FIG. 11 is a flowchart illustrating sensing data analyzing processing (processing S35) of processing S2 in the management device 30. FIGS. 2 and 3 are appropriately referred to. The sensing data selection unit 34 selects a response instruction to the mobile body on the basis of the flag data 21, the sensing data, and the instruction determination table 42.

The sensing data analysis unit 35 determines whether or not the mobile body is a person (processing S351), and if the mobile body is a person, analyzes the person coordinates from the acquired sensing data (processing S353), analyzes the posture movement (processing S354), analyzes the vitals (processing S355), analyzes the surrounding environment of the person (processing S356), then generates instruction information (processing S357), and ends the sensing data analyzing process (processing S35) of processing S2. In a case where the mobile body is not a person (processing S351, No), the sensing data analysis unit 35 proceeds to processing S352.

Note that vital is an abbreviation of vital signs. This is the most basic information about the patient’s life, which is also translated as sign of life (vital). Specifically, it often refers to four of a pulse or a heart rate, a respiration (rate), a blood pressure, and a body temperature, and the current state of a person is grasped and expressed from these numerical information.

In processing S353 to processing S346, in a case where the responsiveness level is “1” and information indicating that the posture is slow walking and the complexion is bad is notified as the state information, the sensing data analysis unit 35 determines the walking speed from the position coordinates and traffic line of a person, determines the vital state such as the complexion, the pulse, and the fatigue level from the image data of the person, determines the posture and the fatigue level from the distance data of the person, and determines the comfort level of the working environment from the temperature and humidity around the person.

In processing S357, the determination criteria are that a break of 1 h or more is required when the fatigue level is 80% or more, that a rescue is required when the posture is crouched or collapsed, that a break of 1 h or more is required when the traffic line and the walking speed are wobble or the leg is entangled, and that a break of 0.5 h is required when the temperature/humidity is 39 degrees/90% is 1 h.

In processing S353 to processing S346, when the responsiveness level is “2” and information indicating that the machine and the person are approaching rapidly is notified as the state information, the sensing data analysis unit 35 determines the predicted closest approach distance and the predicted time for the closest approach distance from the position coordinates and the traffic line of the person and the position coordinates and the traffic line of the machine.

In the processing S357, the determination criteria indicate that the machine is stopped when the closest approach distance is 3 m/predicted time is reached in 15 s, or otherwise, an alarm is issued to a person, the moving speed of the machine is decreased, and the route is changed.

In processing S357, when the responsiveness level is “3” and information of torrential rain is notified as the state information, the sensing data analysis unit 35 determines whether or not the activity can be continued from the rainfall amount and the rainfall situation of the surrounding image data. As determination criteria, according to the results of the rainfall meter and the image recognition, when 500 mm/h continues for 0.5 h, a machine is stopped, and when 500 mm/h continues for 1 h, the machine is evacuated.

The sensing data analysis unit 35 determines whether or not the mobile body is an unmanned construction machine (processing S352), and if the mobile body is an unmanned construction machine (processing S352, Yes), analyzes machine coordinates from the acquired sensing data (processing S360), analyzes a surrounding environment (processing S361), analyzes a machine state (processing S362), then generates instruction information (processing S363), and ends the sensing data analysis processing (processing S35) of processing S2. When the mobile body is not an unmanned construction machine (processing S352, No), the sensing data analysis unit 35 proceeds to processing S365.

In processing S360 to processing S362, when the importance level is “1” and the information of the destruction of the building is notified as the state information, the sensing data analysis unit 35 determines the closest approach distance from the position coordinates and traffic line of the person and the position coordinates and traffic line of the machine, and determines the necessity of evacuation from the surrounding image data and the surrounding distance data.

In processing S363, the determination criteria indicate that the machine is stopped when the closest approach distance is 3 m, and evacuation is required when an unrecognized object or an object that should not approach is detected as a result of image recognition of the surrounding image data and the distance data.

In processing S360 to processing S362, when the importance level is “2” and the information of self-destruction is notified as the state information, the sensing data analysis unit 35 detects a specific frequency at which a failure or deterioration of a component can be predicted from a sound of a machine, and detects a portion at which a temperature reaches a temperature equal to or higher than expected from the temperature.

In processing S363, the determination criteria indicate that the machine is stopped when a specific frequency is detected and the detection state continues for 1 minute as a result of the analysis of the sound of the machine, and the machine is stopped when a site of 90 degrees or more is detected and the detection state continues for 1 minute as a result of the analysis of the temperature.

In processing S360 to processing S362, when the importance level is “3” and the information indicating that the maintenance is required is notified as the state information, the sensing data analysis unit 35 detects a specific frequency at which the failure or deterioration of the component can be predicted from the sound of the machine, detects a part at which the temperature reaches a temperature equal to or higher than expected from the temperature, determines whether the maintenance work is required from the continuous operating time, and estimates the moving time from the current location to the maintenance place from the surrounding image data, the surrounding distance data, the position coordinates and the traffic line of the machine.

In the processing S363, as determination criteria, it is determined that maintenance is required when a specific frequency is detected as a result of analysis of a sound of a machine, it is determined that maintenance is required when a part of 90 degrees or more is detected as a result of analysis of a temperature, it is determined that maintenance is required when a continuous operating time is 50 h or more, and a required moving time and a remaining operating time are calculated from an own position, a surrounding image, and distance data.

In processing S365, the sensing data analysis unit 35 analyzes the surrounding environment, generates instruction information (processing S366), and ends the sensing data analyzing process (processing S35) in processing S2.

In a case where the intervention level is “1” and information indicating that expert judgment is required is notified as the state information in processing S365, the sensing data analysis unit 35 determines a response method in a case where a plurality of abnormalities have occurred by an expert on the basis of position coordinates and traffic lines of a person, image data of the person, distance data of the person, temperature and humidity around the person, position coordinates and traffic lines of a machine, image data of the surroundings, distance data of the surroundings, temperature and humidity around the machine, rainfall, sound of the machine, and temperature of the machine. For example, it is a priority determination at the time of simultaneous occurrence of a plurality of flags or an evacuation instruction at the time of conflict between an evacuation destination and a movement destination of the person/machine.

In processing S365, when the information that the intervention level is “2” and the artificial intelligence instruction is required is notified as the state information, the sensing data analysis unit 35 determines, from the database, the response method in a case where the isolated abnormality in which the artificial intelligence is not included in a first aid processing list has occurred based on the same data group as in the case where the intervention level is “1”. For example, the method is a method of coping with a case where an unknown object not in the list is recognized as a result of image recognition, or a case where an abnormal sound with a frequency not in the list is detected.

In processing S365, when the intervention level is “3” and information indicating only the first aid is notified as the state information, the sensing data analysis unit 35 does not need the determination processing.

FIG. 12 is a diagram illustrating instruction contents based on the flag data and the sensing data in the processing S2. In a case where the responsiveness level is “1” and information indicating that the posture is slow walking and the complexion is bad is notified as the state information, the row 431 is an instruction that a break of 1 h or more is required since it is determined that the walking speed is 2 km/h and the user is walking unsteadily from the traffic line and the distance data, it is determined that a vital state in which the fatigue level is 90% occurs from the complexion, and it is determined that the comfort level of the working environment is bad since the temperature and humidity are 37 degrees and 90%.

When the responsiveness level is “2” and the information that a machine and a person are approaching rapidly is notified as the state information, the row 432 is an instruction of speed reduction of the machine because it is determined that the moving speed of the person is 4 km/h, the moving speed of the machine is 40 km/h, the predicted closest approach distance between the person and the machine is 1 m, and the predicted time for the closest approach distance is reached in 20 seconds.

In a case where the responsiveness level is “3” and information of torrential rain is notified as the state information, the rainfall amount of 100 m continues for 5 hours, rainfall is confirmed from the rainfall situation of the surrounding image data, and it is determined that the activity cannot be continued, thus the row 433 gives an instruction to stop a machine.

In a case where the importance level is “1” and information indicating that a building is destroyed is notified as the state information, it is determined that there is another machine in the periphery but there is no person from the closest approach distance of 5 m between a person and a machine and the analysis result of the image and the distance data, and thus the row 434 is an instruction to evacuate the machine.

In a case where the importance level is “2” and the information of self-destruction is notified as the state information, the row 435 is an instruction to stop a machine since a specific frequency of 90 Hz is detected for 1 minute or more from the sound of the machine and a portion that reaches 90 degrees or more and in which the temperature continues for 1 minute or more is detected from the temperature.

When the information that the maintenance is required is notified as the state information with the importance level of “3”, a specific frequency (90 Hz) is detected, a part having a temperature of 90 degrees or more is detected, and the continuous operating time is 50 h or more, and it is determined that the required movement time is 2 h and the remaining operation time is 6 h from the own position, the surrounding image, and the distance data. Therefore, the row 436 is an instruction to end the work after at most 4 hours and shift to the maintenance work.

In a case where the intervention level is “1” and information indicating that expert judgment is required is notified as the state information, the row 437 is an instruction to stop three machines and issue an alarm to a person since the expert recognizes that a plurality of abnormalities such as two machines approaching and recognizes that there is a person near the evacuation destination on the basis of the position coordinates/traffic line of the person, the image data of the person, the distance data of the person, the temperature and humidity around the person, the position coordinates/traffic line of the machine, the image data of the surroundings, the distance data of the surroundings, the temperature and humidity of the surroundings, the rainfall, the sound of the machine, and the temperature of the machine.

In a case where the intervention level is “2” and the information that the artificial intelligence instruction is required is notified as the state information, the row 438 is an instruction to stop a machine and to give an alarm to a person existing in the periphery and the abnormal intruding vehicle since the artificial intelligence determines that the unknown object is the abnormal intruding vehicle from the analysis result from the database of the image data based on the same data group as that in the case where the intervention level is “1”.

In the row 439, when the intervention level is “3” and information indicating only the first aid is notified as the state information, there is no instruction.

According to the above embodiment, the following features are provided.

An abnormal state monitoring system 100 for a mobile body includes a management device 30 that, based on unsteady information of an abnormal state transmitted from a plurality of the mobile bodies, transmits instruction information to the mobile bodies, and a mobile body side device 10 provided in each of the mobile bodies. The mobile body side device 10 includes a communication unit (for example, the communication unit 25) that communicates with the management device 30, a sensor information acquisition unit (for example, the sensor information acquisition unit 12) that acquires sensor information of a plurality of sensors, an abnormality detection unit (for example, abnormality detection unit 13) that determines whether the sensor information is abnormal, and a control unit (for example, the abnormality processing unit 14 and the flag generation unit 15) that creates a flag indicating an abnormality level and state information indicating an abnormal state as flag data 21 when the abnormality detection unit determines that the abnormality is abnormal, and transmits the flag data to the management device. As a result, since the size of the notification data (flag data 21 (see FIG. 3)) from the mobile body side device 10 to the management device 30 is small, there is an effect that the management device 30 can be notified in real time even if a large number of notifications are simultaneously generated from a large number of bases.

The management device 30 includes the storage unit 40 that stores the acquired data determination table 41 associating the abnormality level, the state information, and the acquired data, and when receiving the flag data 21 from the mobile body side device 10, can transmit an instruction to acquire necessary sensing data to the mobile body side device 10 according to the abnormality level of the flag data 21.

Furthermore, the management device 30 stores a coping method determination table for determining a coping method on the basis of the abnormality level, the state information, and the sensing data in the storage unit 40, and when receiving the sensing data from the mobile body side device 10, the management device can transmit instruction information, which is a coping method for the mobile body, to the mobile body side device 10 on the basis of the coping method determination table (for example, instruction determination table 42).

The flag data 21 includes responsiveness information for determining whether or not an abnormality of a person or an influence on a person is given, importance information for determining whether or not a large influence is given to the surrounding environment, and intervention information for determining whether or not an expert intervention is required among remote instructions. As a result, since urgency and importance are determined before notification from the mobile body side device 10 to the management device 30, a processing load on a side of the management device 30 is small. Further, there is an effect that the management device 30 can easily determine the priority and can cope with a large number of mobile bodies.

In the present embodiment, the mobile body has been described as an unmanned construction machine and a site worker at a construction site, but the mobile body is not limited thereto. For example, there are an unmanned transport vehicle that transports goods in a warehouse and an automatic unmanned vehicle on a road.

### Reference Signs List

10 mobile body side device
11 processing unit
12 sensor information acquisition unit (sensor information acquisition means)
13 abnormality detection unit (abnormality detection means)
14 abnormality processing unit (control unit)
15 flag generation unit (control unit)
20 storage unit
21 flag data
25 communication unit (communication means)
26, 27 sensor
30 management device
31 processing unit
32 priority determination unit
33 mobile body state monitoring unit
34 sensing data selection unit
35 sensing data analysis unit
40 storage unit
41 acquisition data determination table
42 instruction determination table (coping method determination table)
43 instruction content
44 notification data
100 abnormal state monitoring system for mobile body
214 responsiveness information
215 importance information
216 intervention information
214L, 215L, 216L level
214S, 215S, 216S state information

1. An abnormal state monitoring system for a mobile body, comprising:
a management device that, based on unsteady information of an abnormal state transmitted from a plurality of the mobile bodies, transmits instruction information to the mobile bodies; and
a mobile body side device provided in each of the mobile bodies,
wherein
the mobile body side device includes
a communication unit that communicates with the management device,
a sensor information acquisition unit that acquires sensor information of a plurality of sensors,
an abnormality detection unit that determines whether or not the sensor information is abnormal, and
a control unit that generates flag data including a flag indicating an abnormality level and state information indicating an abnormal state when the abnormality detection unit determines that there is an abnormality, and transmits the flag data to the management device.

2. The abnormal state monitoring system for a mobile body according to claim 1, wherein
the management device includes
a storage unit that stores a data acquisition determination table associating the abnormality level, the state information, and acquired data, and
transmits an instruction to acquire necessary sensing data to the mobile body side device according to the abnormality level of the flag data when the flag data is received from the mobile body side device.

3. The abnormal state monitoring system for a mobile body according to claim 2, wherein
the management device
stores a coping method determination table that determines a coping method based on the abnormality level, the state information, and the sensing data in the storage unit, and
transmits instruction information that is a coping method for the mobile bodies to the mobile body side device based on the coping method determination table when the sensing data is received from the mobile body side device.

4. The abnormal state monitoring system for a mobile body according to claim 1, wherein
the flag data includes
responsiveness information for determining whether or not an abnormality of a person or an influence on a person is given,
importance information for determining whether or not a large influence is given to a surrounding environment, and
intervention information for determining whether or not an expert intervention is required among remote instructions.

5. The abnormal state monitoring system for a mobile body according to claim 1, wherein the mobile body includes an unmanned construction machine at a construction site and a site worker.
